(19) United States
(12) Patent Application Publication
(10) Pub. No.: US 2017/0167492 A1
(43) Pub. Date: Jun. 15, 2017

(54) METHOD FOR CONTROLLING AN ELECTRIC VENTILATOR

(71) Applicant: SPAL AUTOMOTIVE S.r.l., Correggio (RE) (IT)

(72) Inventor: Pietro DeFILIPPIS, Varazze (IT)

(21) Appl. No.: 15/325,904

(22) PCT Filed: Jul. 16, 2015
(86) PCT No.: PCT/IB2015/055382

§ 371 Date: Jan. 12, 2017

(30) Foreign Application Priority Data
Jul. 16, 2014 (IT) BO2014A000408

(51) Int. Cl. F04D 25/08; H02H 7/085; H02P 29/60; F04D 27/00

(52) U.S. Cl. CPC F04D 25/08; F04D 27/008; H02H 7/0852; H02P 29/60; H02H 5/04

(57) ABSTRACT

A method for controlling an electric ventilator includes: setting a first threshold temperature T1_{D} of a microcontroller lower than a maximum threshold temperature T3_{D} of the microcontroller; monitoring a temperature T_{D} of the microcontroller; setting a first threshold temperature T1_{M} of an electronic power device lower than a maximum threshold temperature T3_{M} of the electronic power device; monitoring a temperature T_{M} of the electronic power device; preparing a counter of a predetermined time X; activating the counter if the temperature T_{D} or the temperature T_{M} exceeds respective first threshold temperatures T1_{D}, T1_{M}; reducing a speed V of rotation of an electric motor to a second value V1 lower than a first value V1 if after the predetermined time X, the temperature T_{D} or the temperature T_{M} is higher than the respective first threshold temperatures T1_{D}, T1_{M}.

### TECHNICAL FIELD

This invention relates to a method for controlling an electric ventilator and in particular a method for controlling the electric motor of an electric ventilator in automotive applications.

### BACKGROUND ART

Electric ventilators are widely used in the automotive sector with functions of cooling and removing heat from radiating masses.

The electric ventilators comprise, in short, an electric motor, a fan driven by the electric motor and electronics for controlling the motor.

A distinctive feature of the control electronics is also the possibility of protecting the electric motor and the electronics from any overheating or over-temperatures, determined, for example, by particularly severe operating conditions, such as a high ambient temperature or sudden drawbacks.

More specifically, the overheatings are delicate in electric ventilators comprising electric motors of the closed and/or sealed type with control electronics fitted inside, in which the heat dissipation is of even greater importance and must be significantly reduced.

In general, the electric ventilator and the control electronics are characterised by precise temperature ranges wherein the operation is optimum and safe and the nominal performance is guaranteed.

If there is a temperature increase in the motor above the permissible maximum values, even though it is operating at nominal values, it is necessary to intervene in order to protect the control electronics, especially the electronic components, against possible damage.

One control strategy comprises, in the case of temperature increases beyond the permissible values, “degrading” the motor, that is to say, reducing the efficiency and power outputs compared with the nominal performance levels, which are no longer guaranteed, in order to preserve the control electronics.

The degrading is used, in practice, to lower the working temperature of the motor in order to counteract, for example, an increase in the outside temperature.

In general, the control electronics comprise, amongst the other electronic components, a microcontroller and a plurality of electronic power components, such as, for example, MOSFETs.

A known control method comprises monitoring the temperature of the microcontroller, or the card on which it is installed, and the power MOSFETs; if the temperature of the MOSFETs reaches a respective maximum threshold temperature, the motor is stopped.

With reference to FIGS. 1A and 1B, relating to this known control method, considering the temperature of the microcontroller, starting from a working condition at the nominal speed Vₙ, if the temperature of the microcontroller T_{micro} reaches a respective first threshold temperature T_{der} a process is activated for degrading the performance of the electric ventilator with a corresponding reduction in the speed of the motor, for example with a proportional error at ΔT, up to a value Vₘᵢₙᵤₜₑₛ beyond which the electric ventilator continues to rotate at a extremely reduced constant speed compared with the nominal speed.

If the temperature of the microcontroller continuous to rise, despite the degrading, to a second threshold temperature Tₘₐₓ, the motor is stopped and the speed is changed to 0.

In practice, the degrading is controlled by a regulating device, for example PI, based on the temperature error; in the case, not illustrated, in which the temperature of the microcontroller drops again below T_{der} before the motor stops, the speed is again increased to Vₙ.

The main drawback of this control and protection method is that, under certain conditions, the speed of rotation of the electric ventilator might be excessively reduced, placing at risk the entire vehicle on which the electric ventilator is installed, in cases in which the over-temperature is caused by a transient event which passes in a relatively short time.

### DISCLOSURE OF THE INVENTION

In this context, the main aim of this invention is to overcome the above-mentioned drawback.

The aim of this invention is to propose a method for controlling an electric ventilator which increases the safety of the entire vehicle, avoiding a degrading or even a too sudden switching off of the electric ventilator.

The technical purpose indicated and the aims specified are substantially achieved by a control method according to claim 1.

### BRIEF DESCRIPTION OF DRAWINGS

Further features and advantages of this invention are more apparent in the detailed description below, with reference to a preferred, non-restricting, embodiment of a control method for an electric ventilator as schematically illustrated in the accompanying drawings, in which:

FIG. 1A illustrates an example of the temperature diagram of the microcontroller as a function of time in a control method of known type;

FIG. 1B illustrates a diagram of the rotation speed of the motor as a function of time correlated with the diagram of FIG. 1A of the control method of known type;

FIG. 2 illustrates a block diagram of the control method according to this invention;

FIGS. 3A to 3D illustrate, respectively, the diagrams, as a function of time, of the temperature of the microcontroller, the temperature of the MOSFETs, of a counter timeout and of the speed of rotation of the motor in the control method according to this invention.

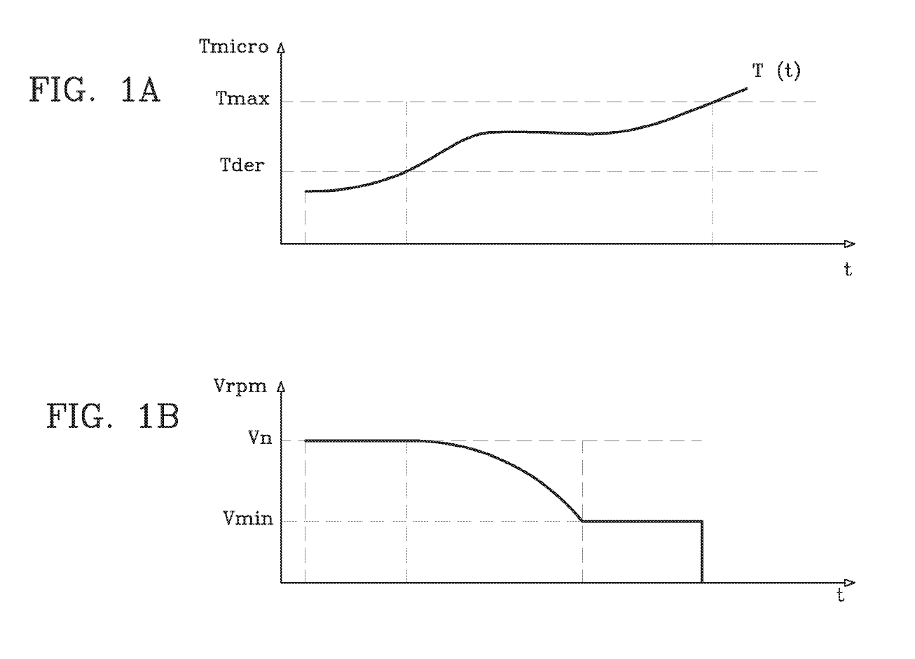

### DETAILED DESCRIPTION OF PREFERRED EMBODIMENTS OF THE INVENTION

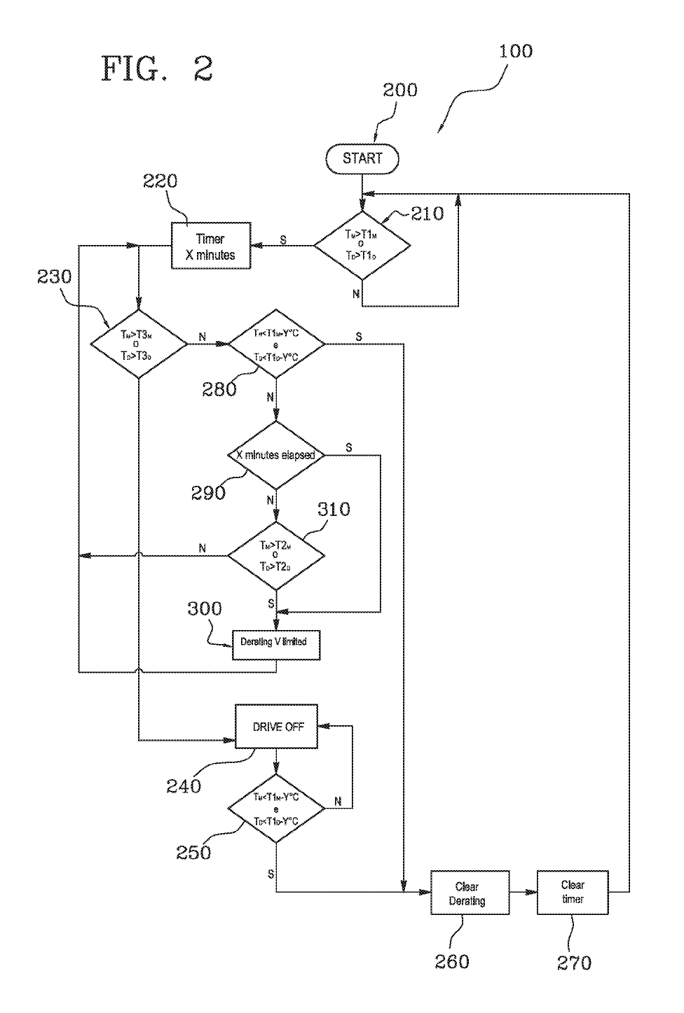

With reference to FIG. 2, the numeral 100 denotes a block diagram relative to the method for controlling an electric ventilator of substantially known type and not illustrated.

The electric ventilator preferably controlled according to this method comprises, very briefly, an electric motor, a fan driven by the electric motor and a card for driving and controlling the electric motor.

The electronic card is preferably housed inside the motor which in turn is preferably of the sealed type.

The electronic card comprises a microcontroller or driver and electronic power means which comprise, for example and preferably, MOSFETs, to which explicit reference will be made, for controlling and powering the electric motor.

The electronic card imparts the speed V of rotation to the motor.

The microcontroller has a relative temperature T_{D} and the MOSFETs have a relative temperature T_{M}.

The method, according to this invention, for controlling the electric ventilator comprises, after the motor is started, defining or setting a first value V1 of the speed V of rotation of the electric motor, in general corresponding to the nominal speed of the electric ventilator, that is, the speed at which the electric ventilator guarantees the nominal performance.

The method comprises a step for defining or setting a maximum threshold temperature T3_{M} of the electronic power means, more specifically of the MOSFETs.

The method comprises a step for defining or setting a maximum threshold temperature T3_{D} of the microcontroller.

The method comprises a step for defining or setting a first threshold temperature T1_{D} of the microcontroller which is lower than the maximum threshold temperature T3_{D} of the microcontroller.

The method comprises a step for defining or setting a first threshold temperature T1_{M} of the electronic power means, more specifically of the MOSFETs, which is lower than the maximum threshold temperature T3_{M} of the MOSFETS.

The method comprises a step for defining or setting a second threshold temperature T2_{D} of the microcontroller which is lower than the maximum threshold temperature T3_{D} of the microcontroller and higher than the first temperature T1_{D} of the microcontroller.

The method comprises a step for defining or setting a second threshold temperature T2_{M} of the electronic power means, more specifically of the MOSFETs, which is lower than the maximum threshold temperature T3_{M} of the MOSFETS and higher than the first threshold temperature T1_{M} of the electronic power means.

In a preferred embodiment, the first threshold temperature T1_{D} of the microcontroller is higher than or equal to 145° C. and is lower than 150° C., that is to say:

145° C.≦T1_{D}<150° C.

In a preferred embodiment, the second threshold temperature T2_{D} of the microcontroller is higher than or equal to 150° C. and is lower than 155° C., that is to say:

150° C.≦T2_{D}<155° C.

In a preferred embodiment, the maximum threshold temperature T3_{D} of the microcontroller is higher than or equal to 155° C. and is lower than 160° C., that is to say:

155° C.≦T3_{D}<160° C.

In a preferred embodiment, the first threshold temperature T1_{M} of the electronic power means is higher than or equal to 150° C. and is lower than 155° C., that is to say:

150° C.≦T1_{M}<155° C.

In a preferred embodiment, the second threshold temperature T2_{M} of the electronic power means is higher than or equal to 155° C. and is lower than 160° C., that is to say:

155° C.≦T2_{M}<160° C.

In a preferred embodiment, the maximum threshold temperature T3_{M} of the electronic power means is higher than or equal to 155° C. and is lower than 160° C., that is to say:

155° C.≦T3_{M}<160° C.

The method comprises monitoring the temperature T_{D} of the microcontroller and monitoring the temperature T_{M} of the electronic power means, more specifically of the MOSFETs.

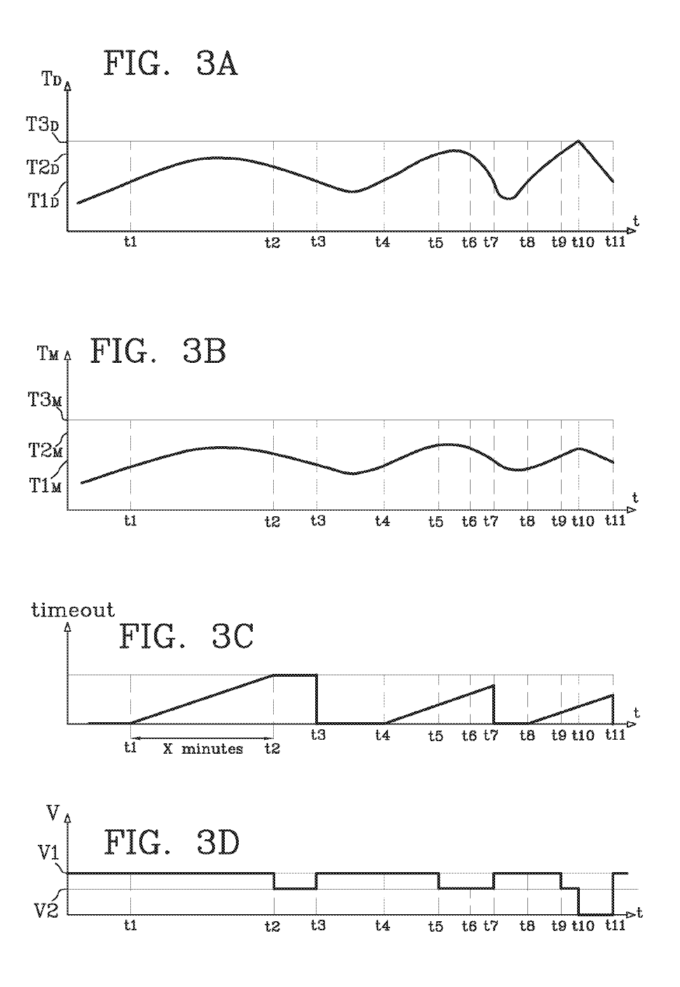

FIGS. 3A and 3B show, respectively, an example of the trend over time of the temperature of the microcontroller T_{D} and an example of the trend over time of the temperature T_{M} of the electronic power means, more specifically of the MOSFETs.

The diagrams of FIGS. 3A and 3B show in order also the respective above-mentioned thresholds of temperatures T1_{D}, T2_{D}, T3_{D} and T1_{M}, T2_{M}, T3_{M}.

It should be noted that, in short and for practical purposes, reference is made to the temperatures of the microcontroller and of the MOSFETs; advantageously, it is also possible to implement this method considering the temperatures in substantial correspondence of the microcontroller or of the MOSFETs, or monitoring them indirectly, for example by monitoring the temperature of the electronic card corresponding with these components.

According to this invention, the control method comprises providing a counter of a predetermined time X; the counter, suitably controlled, as described in more detail below, counts the passage of time X.

The predetermined time X is preferably between 2 minutes and 5 minutes, that is to say:

2 minutes≦X≦5 minutes

Preferably, the time X corresponds to 3 minutes, the period of time to which explicit reference is made hereinafter without thereby limiting the scope of the invention.

With reference in particular to FIG. 2, once the nominal speed V1 of the motor has been set a control method or procedure, in particular for protecting the motor, is performed as follows.

The block 200 indicates the start of the process.

If the temperature of the microcontroller or of the MOSFETs exceeds the respective first threshold temperature T1_{D} or T1_{M} block 210 the counter is started block 220.

If the temperature of the microcontroller and of the MOSFETs remains below the respective first threshold temperature T1_{D} or T1_{M} block 210 the process remains closed on the block 210.

If the temperature of the microcontroller or the temperature of the MOSFETs exceeds the respective maximum threshold temperature T3_{D} and T3_{M} block 230 the motor is stopped block 240, that is, the speed of rotation V is degraded to 0.

Once the motor has been switched off block 250, the process checks if the temperature of the microcontroller and the temperature of the MOSFETs have both dropped below the respective first threshold temperatures T1_{D}, T1_{M}, preferably reduced by a constant Y which makes the control method more robust, preferably between 2 and 8 degrees Centigrade; reference is also made hereinafter, for simplicity, to the threshold temperatures without further indicating the hysteresis constants Y; in particular, the indication of the thermal hysteresis is omitted in FIGS. 3A-3D.

If the temperature T_{D} the microcontroller and the temperature T_{M} of the MOSFETs have both dropped below the respective first threshold temperature T1_{D}, T1_{M}, the motor is restarted block 260 and the counter is stopped and set to zero block 270.

If the temperature of the microcontroller and the temperature of the MOSFETs remain below the respective maximum threshold temperatures T3_{D} and T3_{M} block 230, the process checks if the temperature of the microcontroller and the temperature of the MOSFETs have both dropped below the respective first threshold temperatures T1_{D}, T1_{M}, preferably reduced by the constant Y block 280.

If the temperature of the microcontroller and the temperature of the MOSFETs have both dropped below the respective first threshold temperature T1_{D}, T1_{M}, the counter is stopped and set to zero block 270.

If the temperature of the microcontroller or the temperature of the MOSFETs is still above the respective first threshold temperature T1_{D}, T1_{M} block 280, if the time X counted by the counter has passed block 290, the speed V of rotation of the motor is reduced to a second value V2 block 300.

Preferably, the second value V2 of the speed of rotation is set as the first speed value V1 reduced by a constant percentage D, preferably between 3 and 8, that is to say:

V2=V1−D%

If the temperature of the microcontroller or the temperature of the MOSFETs is still above the respective first threshold temperature T1_{D}, T1_{M}, block 280 and the time X counted by the counter is still progress, the process comprises checking if the temperature T_{D} of the microcontroller or the temperature T_{M} of the MOSFETs has exceeded the respective second threshold temperatures T2_{D} or T2_{M} block 310.

If the temperature of the microcontroller or the temperature of the MOSFETs has exceeded the respective second threshold temperature T2_{D} or T2_{M} , the speed V of rotation of the motor is reduced to the second value V2.

If the temperature of the microcontroller and the temperature of the MOSFETs has not exceeded the respective second threshold temperatures T2_{D} or T2_{M} block 310, the process continues, in practice, from block 230, checking that the temperature of the microcontroller and the temperature of the MOSFETs has not exceeded the respective maximum threshold temperature T3_{D}, T3_{M}.

With reference to FIGS. 3A-3D, an example of the operation of the control method according to this invention is proposed below.

FIG. 3A shows a hypothetical trend of the temperature T_{D} of the microcontroller over time, whilst FIG. 3B shows a hypothetical trend of the temperature T_{M} of the MOSFETs over time.

In the example illustrated, at the instant t1 the temperature T_{D} reaches the respective first threshold temperature T1_{D}, the counter, FIG. 3C “timeout”, starts the count of the three minutes and the speed of rotation remains at the first value V1 corresponding to the nominal speed.

At the instant t2, after the 3 minutes has passed, both the temperature T_{D} of the microcontroller and the temperature T_{M} of the MOSFETs are higher than the respective first threshold temperature T1_{D}, T1_{M} and the speed V of rotation is changed to the value V2, that is, there is a degrading of the speed V of rotation.

At the instant t3, both the temperature T_{D} of the microcontroller and the temperature T_{M} of the MOSFETs are lower than the respective first threshold temperature T1_{D}, T1_{M}, the speed V of rotation is changed to the value V1 and the counter is set to zero.

At the instant t4 the temperature T_{D} of the microcontroller again exceeds the respective first threshold temperature T1_{D} and the counter starts again to count the 3 minutes.

At the instant t5, when the 3 minutes have still not passed, the temperature T_{D} of the microcontroller exceeds the respective second threshold temperature T2_{D}, so the speed is changed to the second value V2 whilst the counter preferably continues the counting.

At the instant t7, when the 3 minutes have still not passed, both the temperatures T_{D} and T_{M} have dropped below the respective first threshold temperature T1_{D}, T1_{M}, so the speed is changed to the value V1 and the counter is set to zero.

At the instant t8 the temperature T_{D} of the microcontroller exceeds the respective first threshold temperature T1_{D} and the counter starts the count of the X minutes.

At the instant t9, within the time X, the temperature T_{D} of the microcontroller exceeds the respective second threshold temperature T2_{D}, so the speed V of rotation of the motor is reduced to the second value V2.

At the instant t10 the temperature T_{D} of the microcontroller reaches its maximum threshold temperature T3_{D}, so the electric motor is immediately stopped and the speed V is changed to 0.

At the instant t11 both the temperature T_{D} of the microcontroller and the temperature T_{M} of the MOSFETs are below the respective first threshold temperatures T1_{D} and T1_{M}, so the motor is restarted at the speed V1 and the counter is set to zero.

In the preferred embodiment illustrated, the counter is not managed from t10 to t11 and the counter remains the same until the reset or zeroing at t11.

The invention described brings important advantages.

The counter introduces a delay in the degrading of the performance of the electric ventilator which is particularly advantageous if the temperature increase is temporary.

If the temperatures drop, during the time X, below the respective first threshold temperatures, the speed is not degraded.

The second threshold temperatures T2_{M} T2_{D} protect the electric motor and the vehicle if the increase in the temperature is relatively sudden and the time measured by the counter is too long.

The operation of the electric ventilator is in any case guaranteed, although at a speed lower than the nominal speed, to protect the entire vehicle even when the above-mentioned thresholds have been exceeded.

The third threshold temperatures T3_{M} T3_{D} ensure the protection of the system by stopping the electric motor if there are excessive over-temperatures.

When one of the temperatures reaches the respective maximum threshold temperature the motor is switched off, since, most likely, the temperature in the motor compartment has reached extremely high values.

The degrading of the speed is constant during predetermined events and is no longer adjusted as a function of the variation in temperature over time.

The electric ventilator continues to work even if the event of temperature increases; even if it is outside the specifications, it operates more than it would with prior art controls.

1. A method for controlling an electric ventilator comprising an electric motor and electronics for controlling the electric motor, the control electronics comprising at least one microcontroller and electronic power means to impart a speed V of rotation to the electric motor, the method comprising the steps of
setting a first value V1 of the speed V of rotation of the electric motor;
setting a maximum threshold temperature T3_{M} of the electronic power means;
setting a maximum threshold temperature T3_{D} of the microcontroller;
setting a first threshold temperature T1_{D} of the microcontroller lower than the maximum threshold temperature T3_{D} of the microcontroller;
monitoring the temperature T_{D} of the microcontroller;
monitoring the temperature T_{M} of the electronic power means;
the method being characterised in that it comprises the steps of
setting a first threshold temperature T1_{M} of the electronic power means lower than the maximum threshold temperature T3_{M} of the electronic power means;
setting a second value V2 of the speed V of rotation of the electric motor lower than the first value V1; preparing a counter of a predetermined time X;
activating the counter if the temperature T_{D} of the microcontroller or the temperature T_{M} of the electronic power means exceeds the respective first threshold temperature T1_{D}, T1_{M};
reducing the speed V of rotation of the electric motor to the second value V2 if after the predetermined time X, the temperature T_{D} of the microcontroller or the temperature T_{M} of the electronic power means is higher than the respective first threshold temperature T1_{D}, T1_{M}.

2. The method according to claim 1, wherein the speed V of rotation of the electric motor is returned to the first value V1 if the temperature T_{D} of the microcontroller and the temperature T_{M} of the electronic power means each become lower than the respective first threshold temperatures T1_{D}, T1_{M}.

3. The method according to claim 1, wherein the speed V of rotation of the electric motor is returned to the first value V1 if the temperature T_{D} of the microcontroller and the temperature T_{M} of the electronic power means each become lower than the respective first threshold temperatures T1_{D}, T1_{M} reduced by a safety factor Y of preferably between 2 and 8 degrees Centigrade.

4. The method according to claim 1, wherein the method comprises the steps of
setting a second threshold temperature T2_{D} of the microcontroller lower than the maximum threshold temperature T3_{D} of the microcontroller and higher than the first threshold temperature T1_{D} of the microcontroller;
setting a second threshold temperature T2_{M} of the electronic power means lower than the maximum threshold temperature T3_{M} of the electronic power means and higher than the first threshold temperature T1_{M} of the electronic power means;
reducing the speed V of rotation of the motor to the second value V2 if during the predetermined time X, the temperature T_{D} of the microcontroller or the temperature T_{M} of the electronic power means exceeds the respective second threshold temperature T2_{D}, T2_{M}.

5. The method according to claim 1, wherein the first speed V1 of rotation is changed to zero, that is, the electric motor is stopped, if the temperature T_{D} of the microcontroller or the temperature T_{M} of the electronic power means exceeds the respective maximum threshold temperature T3_{D}, T3_{M}.

6. The method according to claim 1, wherein the counter is reset if the temperature T_{D} of the microcontroller and the temperature T_{M} of the electronic power means are each lower than the respective first threshold temperature T1_{D}, T1_{M}.

7. The method according to claim 1, wherein the counter is reset if the temperature T_{D} of the microcontroller and the temperature T_{M} of the electronic power means each become lower than the respective first threshold temperature T1_{D}, T1_{M} reduced by a safety factor X of preferably between 2 and 8 degrees Centigrade.

8. The method according to claim 1, wherein the second value V2 of the speed of rotation is set as the first speed value V1 reduced by a constant percentage D, that is to say:
V2=V1−D%.

9. The method according to claim 8, wherein the value of the constant percentage D is between 3 and 8, that is to say:
3≦D≦8.

10. The method according to claim 1, wherein the predetermined time X is between 2 minutes and 5 minutes, that is to say:
2 minutes≦Δt≦5 minutes.

11. The method according to claim 1, wherein the maximum threshold temperature T3_{M} of the electronic power means is higher than or equal to 160° C. and is lower than 165° C., that is to say:
160° C.≦T3_{M}<165° C.

12. The method according to claim 1, wherein the maximum threshold temperature T3_{D} of the microcontroller is higher than or equal to 155° C. and is lower than 160° C., that is to say:
155° C.≦T3_{D}<160° C.

13. The method according to claim 1, wherein the first threshold temperature T1_{D} of the microcontroller is higher than or equal to 145° C. and is lower than 150° C., that is to say:
145° C.≦T1_{D}<150° C.

14. The method according to claim 1, wherein the first threshold temperature T1_{M} of the electronic power means is higher than or equal to 150° C. and is lower than 155° C., that is to say:
150° C.≦T1_{M}<155° C.

15. The method according to claim 4, wherein the second threshold temperature T2_{D} of the microcontroller is higher than or equal to 150° C. and is lower than 155° C., that is to say:
150° C.≦T2_{D}<155° C.

16. The method according to claim 4, wherein the second threshold temperature T2_{M} of the electronic power means is higher than or equal to 155° C. and is lower than 160° C., that is to say:
155° C.≦T2_{M}<160° C.
